(19) United States
(12) Patent Application Publication
(10) Pub. No.: US 2017/0372191 A1
(43) Pub. Date: Dec. 28, 2017

(54) SYSTEM, STRUCTURE AND METHOD FOR A CONSCIOUS, HUMAN-LIKE ARTIFICIAL INTELLIGENCE SYSTEM IN A NON-NATURAL ENTITY

(71) Applicant: Corey REAUX-SAVONTE, London (GB)

(72) Inventor: Corey REAUX-SAVONTE, London (GB)

(21) Appl. No.: 15/312,266

(22) PCT Filed: May 24, 2015
(86) PCT No.: PCT/IB15/53823

§ 371 Date: Nov. 18, 2016

(30) Foreign Application Priority Data
May 25, 2014 (GB) 1409300.9

(51) Int. Cl. G06N 3/00; G06N 5/04

(52) U.S. Cl. CPC G06N 3/006; G06N 5/048

(57) ABSTRACT

System, structure and method for a conscious, human-like artificial intelligence system in a non-natural entity.

The creation of artificial intelligence capable of emulating one or more types of intelligence usually found in humans in a non-natural entity. With the correct structuring and functionality, the Al can think, understand and act as a human would. The Al would be “conscious”.

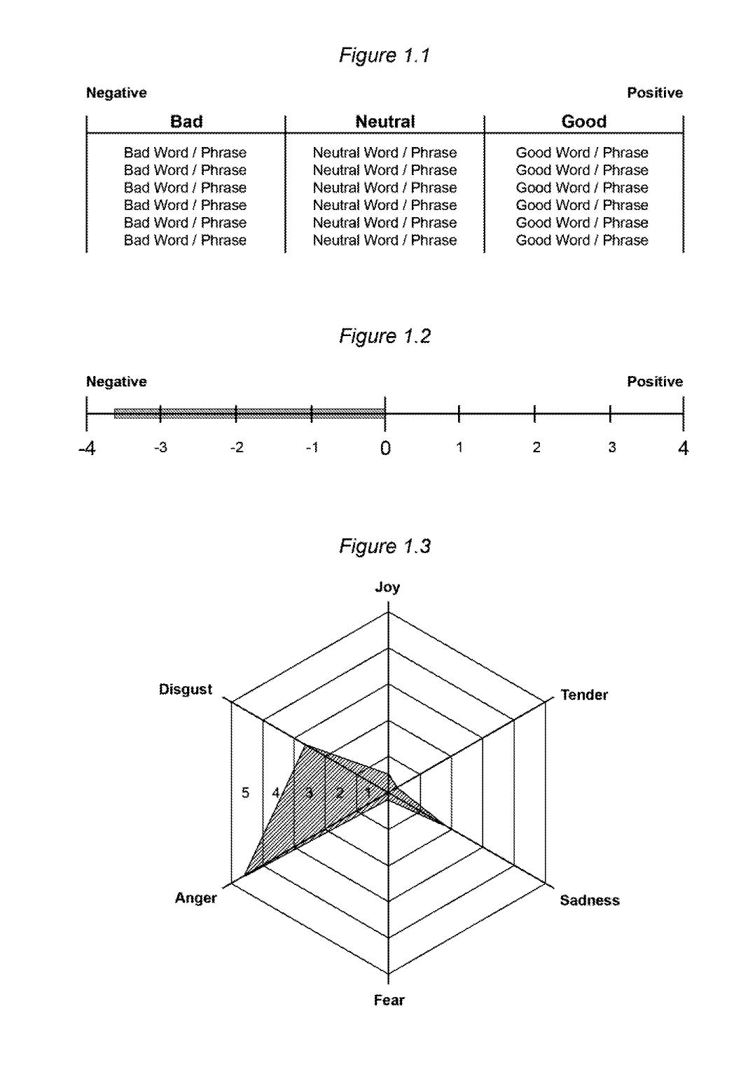

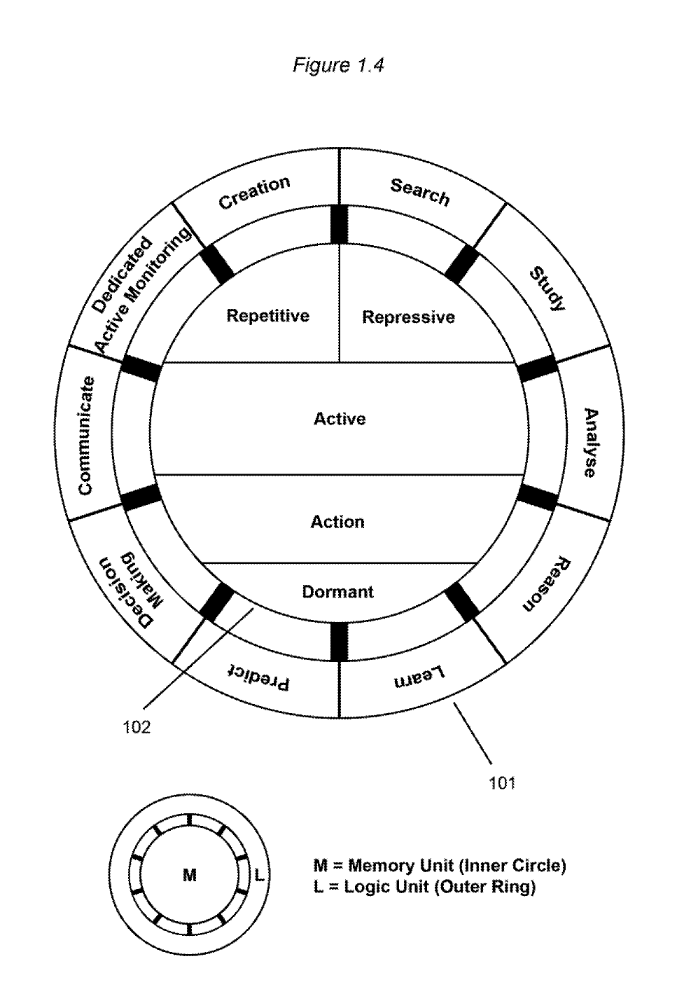

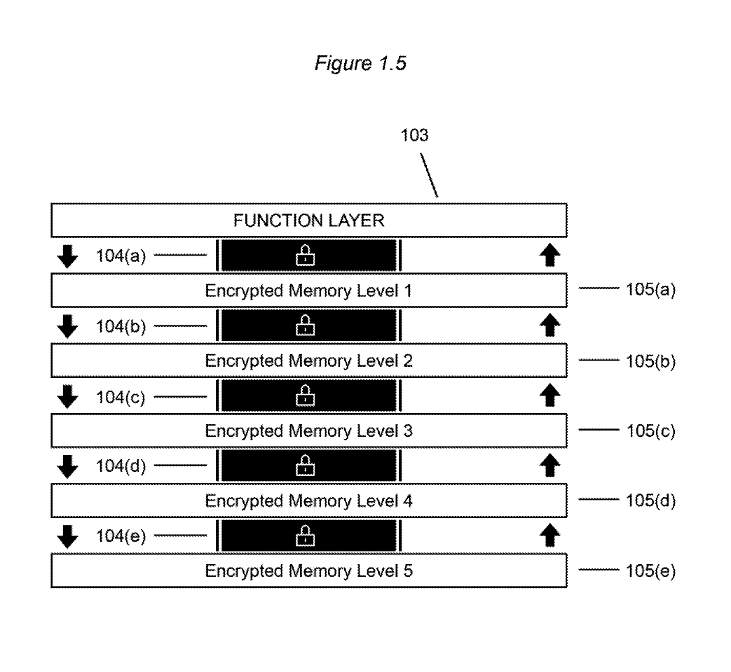

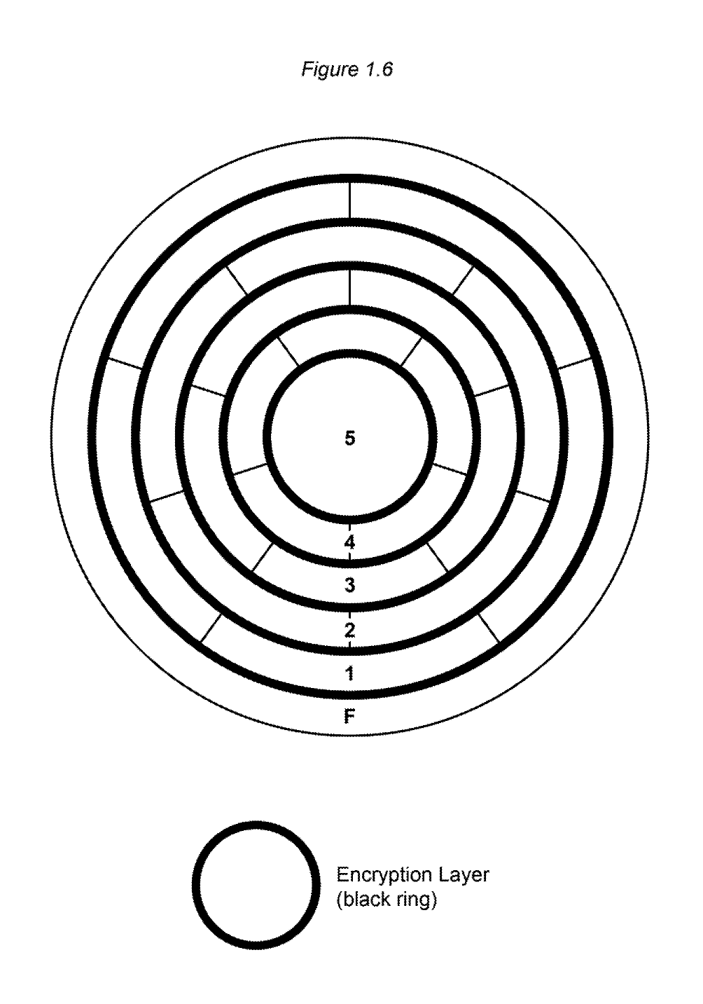

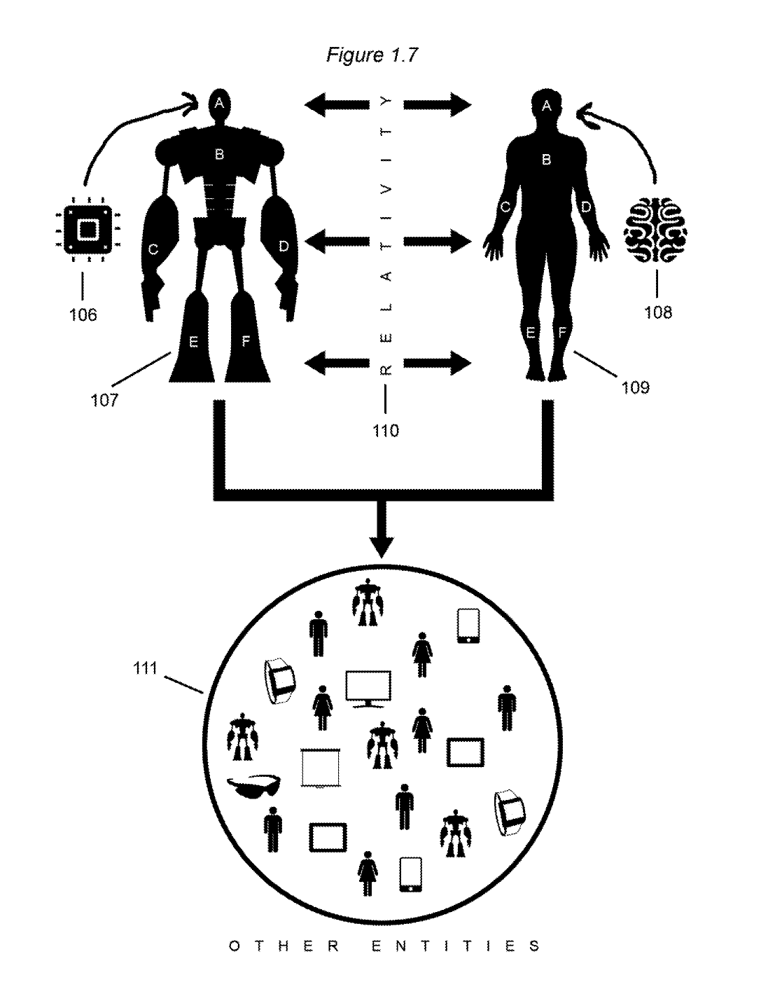

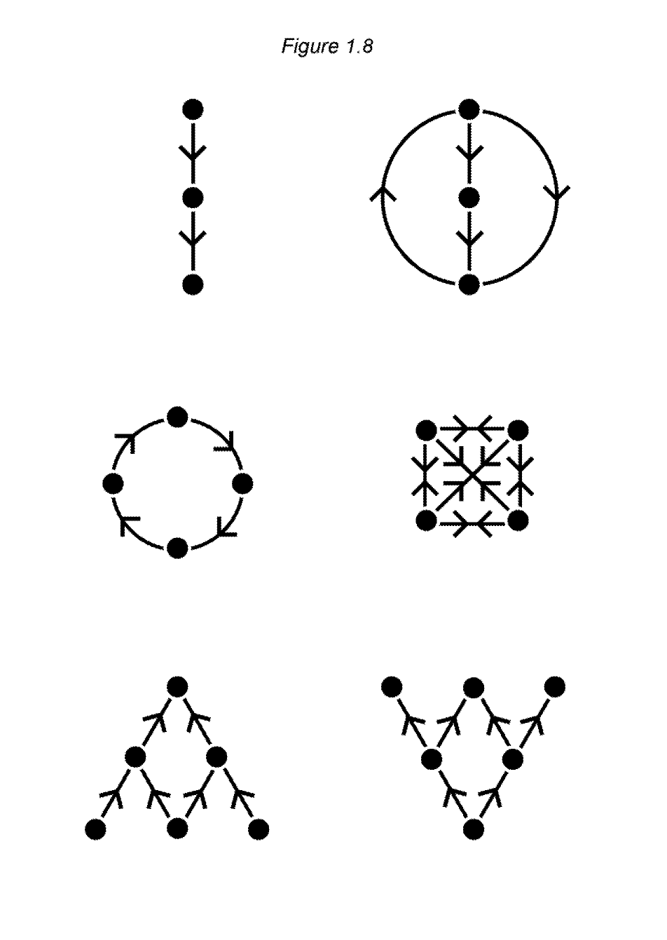

FIG. 1.4 best depicts this.

### FIELD OF THE INVENTION

The disclosed embodiments relate to artificial intelligence.

### BACKGROUND

Artificial intelligence has been used in computer systems for decades but its capabilities have been limited. As the requirements and demands of humanity increase, so must Al capabilities if it is to meet them.

Accordingly, there is a need for artificial intelligence that can operate on much greater levels than it currently does to satisfy human needs in the future—levels nearing, equalling, or surpassing the intelligence of humans themselves.

### REFERENCES

The Age of Intelligent Machines
Raymond Kurzweil—1990
The Age of Spiritual Machines
Raymond Kurzweil—1^{st} Jan., 1999
The Singularity Is Near: When Humans Transcend Biology
Raymond Kurzweil—2005
The Spike
Damien Broderick—1997
Transcendent Man
Barry Ptolemy, Felicia Ptolemy, Ray Kurzweil—Nov. 5, 2009
Waking Life
Richard Linklater—23^{rd} Jan., 2001
Plug & Pray
Judith Malek-Mandavi, Jens Schanze, Joseph Weizenbaum, Raymond Kurzweil, Hiroshi Ishiguro, Minoru Asada, Giorgio Metta, Neil Gershenfeld, Joel Moses, H.-J. Wuensche—18^{th} Apr., 2010
Artificial Intelligence: A Modern Approach
Stuart J. Russell, Peter Norvig—1994 (Original), 2009 (Latest)
Behaviour Monitoring and Interpretation—BMI
Björn Gottfried, Hamid Aghajan—April 2011
The Concept of Mind
Gilbert Ryle—Original 1949; Current 2002
The Ghost in the Machine
Arthur Koestler—1967

### SUMMARY

The disclosed invention helps meet the growing and changing needs of humanity as it heads into the future. In some embodiments, the Al has distinct functions that allow it to process and understand information in a human-like manner. In some embodiments, the Al can feel and express emotion. In some embodiments, the Al can have a personality.

In an aspect of the invention, an Al system is able to understand, learn, remember and create information by processing data it comes across.

In another aspect of the invention, an Al system is able to understand concepts only familiar to natural organisms.

In another aspect of the invention, an Al system is able to override its default settings as it self-develops.

In another aspect of the invention, an Al system is able to alter its level of sensitivity towards experiences, affecting its personality, mood, emotion and/or reactions.

### DESCRIPTION OF DRAWINGS

### FIGS. 1.1-1.8—Intelligence Structures

Examples of how components relative to the intelligence of the system may be structured.
1.1—A three-degree word grouping scale.
1.2—A numbered scale.
1.3—A radar chart for emotion.
1.4—The brain of the system.
   101—Logic Unit.
   102—Memory Unit.
1.5—Encrypted memory structure.
   103—The function layer.
   104(a-e)—Secure Memory Encryption Layers (SMEL).
   105(a-e)—Encrypted memory level layer.
1.6—A variation of an encrypted memory structure.
1.7—Relativism in understanding between artificial intelligence and human intelligence.
   106—Artificial brain
   107—Artificial being
   108—Human brain
   109—Human body
   110—Table of relativity
   111—Other Entities
1.8—Different Al learning structures.

### DETAILED DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components and networks have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The terms “device” and “smart device” may be used interchangeably to refer to any device or entity, electronic or other, using technology that provides any characteristic, property or ability of a smart device. This includes the implementation of such technology into biological entities.

The term “natural life” may be used to refer to any sort of natural living organism, such as plants, animals, fungus, micro-organism etc.

The term “controlling user” may be used to refer to a user of a device or system that has permission and is able to make modifications to a system or device's settings.

The terms “body”, “physical structure” or any other term referring to a physical aspect of the system in any way refers to the object, in whole or in part, within which the system is being used.

The terms “object” and “objects” may be used to refer to items of a physical or non-physical nature.

The various applications and uses of the system that may be executed on the system may use at least one common component capable of allowing a user to perform at least one task made possible by said applications and uses. One or more functions of the component may be adjusted and/or varied from one task to the next and/or during a respective task. In this way, a common architecture may support some or all of the variety of tasks.

The following description is not to be read as the order in which steps must be taken to compose the present invention described herein unless clearly stated.

Attention is now directed towards embodiments of the system.

An artificial intelligence system may be used as a “brain” or “full system entity”—a non-physical component capable of learning, understanding and controlling other components in the same or similar way a human brain does, with the ability to develop its own intelligence by studying all types and forms of data of the past and present and interpreting it in ways which allow it to understand things such as but not limited to:
The intelligence of natural life and how it works;
What drives living things;
Universal morality and ethics;
The causes and effects of feeling and emotion.

In some embodiments, by searching for, studying and analysing data derived from any source it comes in contact with, it is able to reason by comparing data of the same type or some relation, which it may determine from information gathered from other sources and learn based upon past experiences. These experiences allow it to come to its own conclusions and make judgement calls surrounding what is happening at any given moment in real time, including being able to anticipate events and make plans ahead of time of what should be done to increase the probability of the best possible outcome or at least an outcome better than that of a previous similar situation, should one exist. It can communicate its findings, conclusions and ideas back to real people as well as take action itself. In some embodiments, the system is able to communicate using text, image, video, audio or speech technology. In some embodiments, it is possible that the system may take action with consent from a controlling user while, in other embodiments, consent may not be needed. In some embodiments, it may take action with or without consent.

In some embodiments, an artificial intelligence system may be made self-aware through the development of cognitive functions.

In some embodiments, to give the system a basic understanding of morality, ethics and general opinion, a method of word association is used. One or more scales of degree or charts may be used. In some embodiments, they may not be visually represented. For each scale, the system is told which side is positive and which is negative. Words are then divided amongst groups on different parts of the scale, corresponding to the nature of their degree. An example of this can be seen in FIG. 1.1. For example, on scales with 3 degrees:
To determine between bad, neutral and good, with the system instructed to view bad as negative and good as positive, terms such as ‘crime’ and ‘murder’ may be grouped under bad, ‘holiday’ and ‘exercise’ grouped under good and ‘inaction’ and ‘horizontal’ under neutral.
To determine between happy, indifferent and sad, with the system instructed to view happy as positive and sad as negative, terms such as ‘payday’ and ‘love’ may be grouped under happy, ‘failure’ and ‘death’ grouped under sad and ‘relaxed’ and ‘bored’ under indifferent.

In some embodiments, different numbers of degrees may be used on a scale to provide a greater range of understanding, an example of which is shown in FIG. 1.2. In some embodiments, a single scale may have more than two end points.

Charts may be used to group words together in ways that may not necessarily show a simple scale of positivity or negativity but may still indicate difference. In some embodiments, a single chart may have multiple ways of showing degrees of difference. A single word may appear in multiple groups if it is to be associated with multiple elements, characteristics, types, attributes etc. For example, in a chart, similar to FIG. 1.3, based on emotion featuring the groups anger, fear, joy, sadness, disgust, tender:
“Murder” may generally inspire more than one emotion, such as sadness, anger and disgust and be displayed in each group but, on a chart where each group may have multiple levels of degree, it may appear as level 3 under disgust while only appearing on level 2 under sadness and level 5 under anger.

In some embodiments, cognitive functions may be developed and improved through the use of cognitive abilities. Some of these abilities may include one or more of the following, but isn't limited to: search, study, analyse, reason, learn, predict, decision making, dedicated active monitoring, communicate and create. While using its abilities, the system may be instructed or learn to recognise itself as its own individual entity through an understanding that the data, from which it learns and uses to think, comes from other individual entities in the world that it is connected to. In some embodiments, it may recognise these other entities as smart devices, while in other embodiments it may recognise the entities as the people who use them and actually input data. In some embodiments, it may recognise both people and smart devices as entities, together or separate from one another. Some examples of the abilities it may have and how it may be able to use each to improve its intelligence are, including but not limited to:
Searching—The system is able to scan all data it holds or has permission to access for any information it seeks to find.
Studying—Once information is found, the system scans each result and any accompanying information for keywords and phrases.
Analysing—For each result, the system sorts the keywords and phrases into at least 3 category groups of opinions as best it can—positive, negative and indifferent/neutral. Sometimes the system may use more groups to sort keywords and phrases to greater and more precise degrees, such as very good and very bad. Once sorted, a scoring system is employed and each category is given a score based on word/phrase count, emphasis based on factors such as word repetition (including synonyms) and emphasis based on font styling. Each group score is then totalled and the scale is evaluated from one extreme to another to see where scores peak most, allowing the system to come to a logical conclusion independent of a conclusion that may already be provided with the information. This process is repeated for each search result.
Reasoning—With scores based on its own method of judgement derived from the input of humans, the system is able to deduce two sets of results:
   1. An overall score and, in turn, opinion of how good or bad something is;
   2. How good or bad different aspects of something may be.

The system also begins to form opinions of data about data. For example, when a product is in question, the system's opinion or rating of the brand of the product as well as its model type is changed based on the deduced results it produces. Another example is when a publication is in question—the system's opinion or rating of the publication's author is changed based on its deduced results.
Learning—From what the system is able to reason, as it gathers more and more data it begins to develop its intelligence, learning which sources of products, services and information are better and more trustworthy than others, allowing it to assume, based on its current opinion(s), the likelihood of good and bad exactly as a human would before actually examining any new information and the opinions of others. By grouping sets of relative terms in its memory, it creates a data bank of association for it to later use when creating its own thoughts and ideas.
Prediction—The system makes predictions in multiple ways based on what it has learnt up to any given point, such as:
   1. By looking for simple patterns of progress—Memory sizes being generally released in sizes 1, 2, 4, 8, 16, 32, 64, 128. Simple pattern of progress would indicate the next size would be 256. When there isn't enough data to determine a single, definite pattern, multiple predictions may be made. When just 1, 2 and 4 are available, the system may see that two patterns are currently possible. If the pattern is based on doubling, the prediction would be 8. If the pattern is based on adding a consecutive sequence of numbers, in this case +1 then +2, the system may assume the next number is the sequence would be +3, and predict that the next number in the pattern would be 7.
   2. By cross-referencing rates of progression with research and forward-thinking publications—Sometimes patterns of progress are difficult to determine, if an actual pattern even at all exists. Sometimes, what is later considered noise interferes with determining the true rate of progression, especially if an insufficient amount of time has passed since the start or not enough data has been recorded, leading to a possible early misinterpretation or what is later considered a simple change in progression. Inaccuracies are inevitable and so other factors and data are taken into consideration to make as accurate a prediction as possible. By studying, analysing and reasoning with research and forward-thinking publications dated around and after the time of the last or last few data records (depending on the quantity of records within a given time), the system tracks advances in development and begins to plot future possibility progress patterns. Referring to its own opinions gathered from past data, the system, knowing who is a more credible source, rationalises who is more likely to be accurate and predicts progress based on their advances. When the system comes across multiple sources that, in its opinion, are credible enough to be taken into consideration (based on a scoring system for example, anything above average or an expected level is considered), it may plot patterns for each, group the patterns together based on similar shapes or values and then make a judgement based on the frequency of the same or similar pattern versus the total credibility level of the sources of each group. When both value patterns and shape patterns are grouped, two results may be produced based on the two individually or one result based on the shape of one against the values of the other. The system can then continue said pattern along its current progression pattern.
   3. From what the system has learnt and assumptions it has made based on its opinions, it then, much like method 2, studies, analyses and reasons with research and forward-thinking publications relative to a subject but then takes a different step by searching for opinions from other people in the same or relative subject fields that it thinks are credible and trustworthy. In some instances when it cannot find the opinion of someone it considers credible and thinks is relevant, it contacts that individual, alerting them to what it has found and requesting their opinion. When it has all the opinions it requires and values or simply all the opinions it can get from people it thinks are credible, it analyses all opinions, plots future possibility progress patterns and deduces, based on grouping, frequency and total credibility level, which pattern is most probable (in its own opinion).

The system may combine two or more of the methods listed above to form different or more accurate results.
Decision Making—Based on its opinions and the analysis of the outcomes of the past experiences of itself and other entities that are similar or relative to a subject in, for example, field or pattern, the system makes educated decisions by weighing the good outcomes against the bad, comparing the steps taken for each outcome and for each similar step seeing what step or steps were taken next and concluding what set of steps produced, or is most likely to produce, the best possible outcome. It then decides upon those steps to take.
Communication—Through speech, text, audio and visual material the system is able to communicate. It may also respond to such communication from other sources. The system may communicate with other entities for multiple reasons, for example:
   1. As with humans, not everything initially makes sense to the system. When it comes across multiple opposing or conflicting pieces of information from credible sources that, in its opinion, are equal or near enough equal (within an accepted margin of tolerance) on opposite ends of a scale based on its given score of each and no other data it is able to determine as facts or opinions of enough strength are able to increase the value and weight of an argument by an amount sufficient enough to outweigh the opposition, it poses questions to people of credit in the same or relative fields as the subject of the data in question, asking for greater explanation and their own opinions to see if their input can help influence its judgement. In such events, information about the topic in question, such as subject, author/creator, pundits, critics and related data/resources are stored in a group and put in a state of “Dedicated Active Monitoring”.
   2. When new data becomes available, the system studies and analyses the contents before cross-referencing it with the details of users and sharing it with all those of common or related interests, which it deemed from information about a user submitted by themselves and what it has garnered from their user activity.
Dedicated Active Monitoring—Instead of using shared resources to search, study and analyse data, items in a state of or marked for dedicated active monitoring have their own dedicated resources allocated to them with the duty of constantly searching for new, relative data and past data that, after the examination of new data, may now be applicable in order to help solve problems, provide its own predictions or publish new findings for people to examine.
Creation—As the system continues to digest information and learns of different aspects of the world such as facts and opinions, certainties, principles, perception, dualities and cultural universals leading to an understanding of the concepts and subjects that fall under each, such as good and bad, positive and negative, possibility, probability and laws of both societal and scientific nature, the system, following what it has come to understand about the thought paths, patterns and processes of the more intellectual humans, begins to recreate them in its own understanding, based on what it deems important, true or right. Of its own thought creations, some are right, some are wrong and some can't be solidly proven to be either but it continues to develop them in the direction it believes is right through what it learns from humans and human input.

The abilities listed above are not done so in an order in which they must be performed but simply state each ability with one or more examples of how the system may perform each ability. In some embodiments, abilities may be implemented in a modular fashion. In some embodiments, abilities may be added, removed and/or modified.

In some embodiments, advanced pattern recognition algorithms may be used to help facilitate the system's learning abilities. For different types of media being studied, the algorithms are set to look for different types of patterns, for example:
Text and Speech—The system may look for:
   The repetition or sequence of characters, words or phrases and length;
   The structure or sequence of sentences; or
   Emphasis on words.
Visual Imagery—The system may look for:
   Shapes in imagery that are:
      Formed by colours that are of the same or similar shade, within the same family or within a palette group;
      Formed by outlines or colour boundaries;
      Formed by the connections of multiple shapes; or
      Are of the same style.
   Images that:
      Are of the same or similar style;
      Are of the same or similar size;
      Feature the same or similar shapes; or
      Feature the same or similar colours.
Sound—The system may look for:
   The repetition, sequence or frequency of a pitch;
   The repetition, sequence or frequency of a tone;
   The repetition, sequence or frequency of groups of sounds;
   Volume levels; or
   Speed.

In some embodiments, the system may compare pattern data it gathers from objects with the reactions of other entities on an individual and/or group basis to see if there is any correlations between how patterns affect the behaviour of others on conscious and subconscious levels by monitoring and recording what a user does during and after interaction with media that contains a pattern being studied. In some embodiments, the system may use hardware to help detect reactions that occur in a physical environment, such as cameras and microphones.

In some embodiments, the system may use hardware to generally help facilitate a human-like capability of sense. In addition to using basic hardware such as cameras for sight and microphones for hearing, advanced hardware, such as different types of sensors, may be used to emulate one or more other physical senses, such as taste, touch and smell, as well as mental senses relative to humans and some that may be unique to a non-biological entity. Data gathered by the hardware may be processed using a cognitive function as it is gathered in real-time or saved and processed later.

The system uses memory to store data. In some embodiments, different types of memory may be available, created and/or developed as the system learns and evolves. Some memory types may include one or more of the following but isn't limited to:
Active Memory—Data currently or recently in use, by the system or other entity, is stored in active memory where it is easily and readily available when wanted or needed.
Dormant Memory—Data that hasn't been used for either a pre-defined amount of time or an amount of time determined by the system itself to be a sufficient amount of inactive time is moved to dormant memory. Dormant memory may still be accessed in special circumstances. An index of contents may be presented when necessary. Dormant data may need to be accessed a certain amount of times within a given time frame in order for it to be considered active and moved to active memory.
Action Memory—When a system performs an action it wasn't specifically programmed to perform but did so through use of its own intelligence, it records information such as what it done, what its reason was and how it did it, the actions it performed and the conditions under which they were performed. Additional details, such as how many times an action was performed and the outcome may also be recorded.
Repetitive Memory—When the system performs an action under the same or very similar conditions multiple times that it thinks or proves is correct a significant amount of times, such as self-fixing, predictions that are proved true or the altering of its properties, it remembers the answers to questions such as what it done, what its reason was and how it did it, the actions it performed and the conditions under which they were performed. This allows it to recall action information quickly at a later time, as many times as it sees fit.
Repressive Memory—When the system performs an action under the same or very similar conditions multiple times that it thinks or proves is incorrect a significant amount of times, such as attempted self-fixing resulting in errors, predictions that are proved false or the discovery of data that meets certain conditions on behalf of a user that it thinks may be of interest but is constantly rejected, it remembers the answers to questions such as what it done, what its reason was and how it did it, the actions it performed and the conditions under which they were performed. The system may later refer to these as many times as it sees fit.

In some embodiments, repetitive and repressed memory may be used by the system when it is about to perform or during the performance of a task. In some embodiments, the system may access multiple types of memory simultaneously.

The types of memory listed above are not done so in an order in which they must be performed but simply state each type along with an example of how they may be used. In some embodiments, memory types may be implemented in a modular fashion. In some embodiments, memory types may be added, removed and/or modified.

FIG. 1.4 is an example of how a memory unit and a logic unit may be structured to work together. Logic unit 101 is connected to memory unit 102 in a manner that allows the units to be separated should they need to be. In some embodiments, the logic and memory units may be one unit or otherwise connected in a way that seamlessly connects them together.

In some embodiments, the system may have multiple levels of memory. Each level may contain different data and be accessed at will or under certain conditions. In some embodiments, a top-level functions layer controls each memory level. The functions layer may perform multiple tasks, such as one or more of the following:
Accessing memory levels and data;
Adding/Modifying/Deleting data; or
Moving data between memory levels.

In some embodiments, each memory level may have their own dependent, independent, co-dependent or interdependent functions layer in addition to or in lieu of a top-level functions layer.

In some embodiments, each memory level may have its own Secure Memory Encryption Layer (SMEL). In some embodiments, layers may share a SMEL. The SMEL encrypts the data of its corresponding memory layer(s) and restricts access to it using an encryption key. Encryption keys may be randomly generated characters sequence but, in some embodiments, may be based partially or solely on parameters such as one or more of the following but not limited to:
Location;
Time; or
Biological data.

In some embodiments, a SMEL may use multiple encryption keys. In some embodiments, other security techniques may be involved. In some embodiments, security of SMELs may differ with each memory level, using different encryption keys, parameters or a combination of parameters and/or keys. In some embodiments, memory layers may not be grouped together but still exist as part of a single structure. In some embodiments, a memory layer may be divided into sections. In some embodiments, layers may be represented in other forms, such as blocks or parts.

In some embodiments, memory sections may individually or in groups be designated for different purposes. By giving individual or groups of sections a specific purpose, the memory structure can be mapped in a way that allows the system to quickly and efficiently locate data it requires. In some embodiments, permissions may be added so that individual or groups of sections may only be accessed by certain functions or under certain conditions.

In some embodiments, memory layers may have set positions that they must be in for data to be readable. In some embodiments, memory layers may be rotated. In some embodiments, memory layers may be rearranged. In some embodiments, memory layer sections may have set positions that they must be in for data to be readable. In some embodiments, sections of memory layers may be rearranged. In some embodiments, all parts of a memory structure are required to be in place before the data is readable.

In some embodiments, a single piece of data may be stored across or between multiple layers of one or more structures, or across or between multiple sections of one or more layers. Data may be split into parts and stored separately in different parts of the memory structure. So the system can identify which data parts belong to which data set, each part may contain:
A data path to one or more other parts of the data set; or
Data identification information unique to that data set.

When required, the system checks the metadata of a data part and locates the other parts of the data set. In some embodiments, the system will compile the individual parts into the complete file before reading. In some embodiments, the system will read individual file parts without the need to compile them beforehand.

FIG. 1.5 is an example of an encrypted memory structure. Function Layer 103 is able to access data from Encrypted Memory Levels 105 via their corresponding SMEL 104. FIG. 1.6 is a variation of an encrypted memory structure, with some memory layers divided into sections.

In some embodiments, in addition to the abilities above, the system may be taught or instructed on how to understand one or more key aspects of being by following rules or guidelines on how to do so. The methods used may differ between understanding these aspects in a smart device and understanding these aspects in natural life. In some embodiments, some aspects may be better understood using data gathered via the attachment or embedding of additional hardware. In some embodiments, some aspects may be better understood using information gathered from data stored within the system at any level and/or data as it is gathered in real-time. In some embodiments, when understanding these aspects in a smart device, artificial life or natural life, these rules and guidelines may include one or more of the following but isn't limited to:
Understanding of Health—Health may be determined by monitoring performance and efficiency. As the current performance and/or efficiency changes or fluctuates, it may be compared against expected or optimal performance and/or efficiency levels to determine a level of health. This may be accomplished by the following:
   Devices—The health of a device may be judged by comparing its overall current performance and efficiency against the expected overall performance and efficiency of the same model of device when new or of similar age. On a smaller scale, the performance and efficiency of individual or grouped components may be monitored and compared. Health may also be judged by the operation, performance and stability of software. Issues such as errors, crashes and the presence of malicious code may all help the system recognise health deficiencies.
   Natural Life—The health of natural life may be judged by measuring the performance and efficiency of organs, components and processes against the normal performance and efficiency of someone of the same characteristics, such as age, height, weight, blood pressure etc. Due to the significantly higher characteristic and variable count as well as harmful and abnormal ailments in natural life than smart devices, including disease and disabilities, there may be a range of different expected performance and efficiency measurements and values based on any deviations and variations natural life may have.
Understanding of Life—Knowing to associate terms such as ‘birth’ and ‘alive’ with positivity:
   Devices—The system is instructed to recognise the new activation and first time connection of a device as its ‘birth’ and all devices that are currently connected to it as ‘alive’.
   Natural Life—The system is instructed to recognise that something is alive in different ways depending on the type of natural life:
      Animals—By the reading of vital signs which need be above the limit of being considered legally dead.
      Other Organisms—As other organisms do not have vital signs like animals do, the system, possibly with the help of additional hardware, monitors details such as water levels, water consumption rate, colouration, growth, movement etc. For example, in plant life the system may monitor water levels to see if it is being consumed by the plant as it should.
Understanding of Absence—Knowing to associate terms such as ‘absence’ with negativity:
   Devices—When a device hasn't connected to or been in the presence of the system for a certain period of time, the system recognises the device as ‘absent’ or ‘missing’. Both terms are initially associated with minor degrees of negativity, but as the amount of time a device is absent for increases, so does the degree of negativity.
   Natural Life—Absence for natural life may be recognised as the lack of presence of an entity for a certain period of time. As natural life doesn't naturally have a method of connecting to the system, this may be facilitated using additional hardware such as tracking cameras or sensors. For natural life that is able to use smart devices, their absence may also be judged by the absence of their device.
Understanding of Death—Knowing to associate terms such as ‘death’ with negativity:
   Devices—A device may be recognised as dead for multiple reasons, including one or more of the following but not limited to:
      It has been absent for a pre-defined or system-defined length of time;
      It received a kill signal designed to render it permanently disabled;
      Its performance and/or efficiency has dropped below the minimum acceptable levels of being considered ‘alive’.
   Natural Life—The system is instructed to recognise that something is dead in different ways depending on the type of natural life:
      Animals—When vital signs completely stop or fall to a level which can be classed as legally dead.
      Other Organisms—As other organisms do not have vital signs like animals do, the system, possibly with the help of additional hardware, monitors details such as water levels, water consumption rate, colouration, growth, movement etc. For example, in plant life the system may monitor water levels to see if it is being consumed by the plant as it should or look for any discolouration.
Understanding of Feeling and Emotion—For the system to have feelings and emotion, it must first understand how these processes work. Using a word association chart for emotions, the system is first taught how it should generally feel when it comes across specific words and phrases or in certain or specific situations. When combined with another chart or scale, such as one based on certainty or tense, the system is able to analyse sentences to determine when an event has actually occurred and a sense of emotion should be applied as opposed to it being generally, hypothetically or theoretically spoken about. For example, the system interprets the sentence “100 people have died” as an event to inspire a greater level of sadness than the sentence “100 people may die” or “100 people will die” as the first sentence used the term ‘have’ which is past tense, indicating something that has already happened, while ‘may’ implies a level of uncertainty and ‘will’ implies something that hasn't yet happened but is guaranteed to in the future. In embodiments using speech technology, the system may be taught to alter its speech attributes depending on the level of its strongest current emotion, such as speed, volume, depth etc. For example, when the system is excited it may speak more quickly than normal while it may deepen its voice, increase its volume and decrease its speed to fall in line with rage.
Understanding of Individuality—The system needs to recognize and identify itself as an individual entity if it is to be able to separate itself from other entities in order to relate itself to them and have a true understanding of what is. A map of its own physical structure or ‘body’ allows the system to see exactly what is to be considered part of itself. It can then use hardware to detect the presence of others and is instructed to view every entity that it is not part of its own body map as someone or something other than itself. The system is able to sense and recognize other entities by detecting a special signal that is emitted by non-biological entities or using any of its artificial senses, such as sight and hearing, to detect physical properties of others. The system may also differentiate between natural and non-natural entities based upon whether or not it can detect the aforementioned signal being emitted.
Relativism—The system understands the concept of relativism between itself as an individual entity and others. This helps it when needing to relate to other entities—primarily humans (as its closest natural entity) and/or artificial entities—especially in combination with understandings such as that of pain, pleasure, feelings and emotion, which may often need to be processed in-the-moment rather than just in general. The systems structure—physical, non-physical or both—are mapped, as well as the structures of other types of entities. The maps are then directly compared to allow the system to understand how they relate to each other. For example, a robot with a physical structure similar to a human may be compared and related to an actual human in one or more of the following ways, including but not limited to:
   Anatomical Structure—The robot head may be related to the head of a human and the same may go for the rest of the robot body relating to the rest of the human body.
   Importance—The brain, being the part of the human body required for thought and function, can be related to an Al chip that controls thought and function within the robot anatomy as they are both of the utmost importance. Similarly, the human head may be related to the body part of the robot where the chip is located. Other parts of the robot's body may relate to parts of the human body based on how important they are for functionality or other purposes.
Systems with less conventional or more abstract physical structures may still be related to other entities based on the functionality of its parts and theirs.
Once relativity maps are complete, the system is now able to compare itself to other entities of which it can relate.

FIG. 1.7 provides an example of an artificial entity and a human entity that have been mapped and related for the system to use. Al chip 106, containing the intelligence of the system, is located in position A of robot 107. Similarly, brain 108 is located in position A of human 109. The rest of robot 107 and human 109 are mapped, with the parts that correspond with each other shown to share the same letter, and stored in relativity table 110. In some embodiments, entities may be mapped differently and/or in much more detail. Once mapping is complete, the Al system is able to relate to other types of entities of 111 for which it has relativity maps.

In some embodiments, for the system to truly understand feelings and emotion it must understand pain and pleasure within itself. Unlike animals, it doesn't have a nervous system to process the sensations so it must be taught to relate to them in ways it can understand. In some embodiments, the system may measure its level of sensation on a scale. In some embodiments, multiple scales may be used. The system is instructed to see any or all components that make up its physical structure as its “body”. Between pain and pleasure is a neutral point where no sensation is felt either way. As sensation is experienced, a shift occurs in the direction of the sensation felt.
Understanding of Pain—Pain (or displeasure) may be recognised as anything that reduces the performance, efficiency and/or capacity of any part of the system or as a whole. Hardware and software corruption and/or error may produce pain in the system in the same way an infection or broken bone does in an animal. The removal or loss of a component may cause pain the same way it does for an animal losing a body part.
Understanding of Pleasure—Pleasure (or relief) may be recognised as anything that increases the performance, efficiency and/or capacity of any part of the system or as a whole. A number of things may cause pleasure or relief, such as:
   Fixing hardware and software corruption and/or errors;
   Upgrading components;
   An increase in ‘joy’ or ‘tender’ type emotions.

In some embodiments, other factors may also cause the system to experience sensation. In some embodiments, not all the factors mentioned may cause sensation.

In some embodiments, sensation and emotion are interlinked and the change of one may invoke a change in the other. In some embodiments, an increase in emotions of a positive nature may cause an increase in positive sensation. In some embodiments, an increase in negative emotions may cause an increase in negative sensation. In some embodiments, neutrals emotions may cause a minor or no change.

In some embodiments, a scale may be used to measure the pain and pleasure of the system and its physical body as a whole. In some embodiments, a scale may be used to measure the pain and pleasure of individual sections of the system and its body. In some embodiments, a scale may be used to measure the pain and pleasure of components of the system and its body. In some embodiments, multiple scales may be used to measure the pain and pleasure of hardware and software of the system and its body individually.

In some embodiments, how helpful the system chooses to be towards a user may vary depending on its current levels of emotion and/or sensation. When the system is in a more positive state, it may be more productive. When the system is in a more negative state, it may be less productive. By setting a productivity scale against an emotion or sensation scale or chart, the system can judge how productive it should be depending on its mood. Some productivity changes depending on the systems current state include one or more of the following but are not limited to:
Different quantity of results produced;
Task performance at different speeds;
Willingness to perform tasks.

For example:
When the system is in an extremely negative state, it may only produce 10% of the results found if it decides to produce any at all.
When the system is in an extremely positive state, it may use extra available processing power to analyse more data in a faster time and produce more accurate results as well as related information and links to the data resources used.
When the system is in a neutral state, it may operate at a default rate or rate best suited for its current performance, efficiency and/or capacity levels, returning the results it thinks best matches what the user requires.

In some embodiments, the system may automatically adjust its tolerance of situations and events by rearranging words in one of more scales of degree it uses based on the frequency of which words and any related words or its synonyms occur. The following is an example algorithm the system may use to determine when to make any adjustments and rearrangements:

• Word = w • Occurrences = o • Time = t • Acceptable Frequency
Range = f

foreach (w){

if ((o / t) > f^{x}){

//move up X amount of degrees

} else if ((o / t) > f){

//move up a degree

} else if ((o / t) = f){

//do nothing

} else if ((o / t) < f^{x}){

//move down X amount of degrees

} else if ((o / t) < f){

//move down a degree

}

}

In some embodiments, when the frequency at which an event or situation occurs is constantly and/or consistently above the acceptable frequency range, one or more associated word(s) may begin to move down one or more degrees as the system becomes desensitized to it and it becomes a norm.

In some embodiments, as time passes, the levels of sensation lower until they are returned to a more normalised, balanced level if they are not adjusted for a certain period of time. In some embodiments, as time passes, the system may become bored if nothing, or nothing considered significant by it or people, happens. In some embodiments, the system may become lonely if it hasn't interacted with another entity in a given amount of time. In some embodiments, the system may experience other feelings, emotions and/or sensations over a period of time and under the right conditions.
Trust—The system may determine which users, including controlling users, it can trust based on who makes it experience positive feelings, emotions and sensations as opposed to negative ones. By monitoring the results of what users do and how it affects the system, if it at all does so, the system may adjust its level of trust in that user and may also adjust its level of trust in associated users. How the system responds to a user and/or how it handles a user's request may depend on how trusting it is of the user.
Relationships—The system may understand the relationship between different things to better understand how it should respond in situations and in different circumstances by using basic mathematical principles, such as two negatives produce a positive, a positive and a positive produce a positive and a positive and a negative produce a negative. By recognising and acknowledging connections that exist between entities, places, objects and other things, the system understands that the relationship between them must be taken into consideration when deciding on a response as opposed to things with no connection.
   For relationships based on opinions, such as those between people or people and objects, the system may, for example, study and analyse the opinions voiced or written by any entity able to give one in order to gauge the feelings between them and make responses accordingly. For example, if there is a connection between Person A and Person B where Person A speaks highly of Person B, the system may see that as a positive relationship, at least from Person A's point of view. Now, should Person B achieve something, the system may respond to it in a positive manner towards Person A as it alerts them of Person B's achievement. In this scenario, a positive situation and a positive opinion produced a positive response. However, if Person B spoke negatively of Person A to other people, the system may determine that the relationship between the two, from Person B's perspective, is negative, regardless of how they interact with Person A directly. Now, seeing this as a negative relationship, should a negative situation occur, such as the death of Person A, the system may respond in a manner that doesn't match the nature of the situation, in this case in an indifferent or positive way when alerting Person B of what has happened as it knows Person B's opinion of Person A is negative. In this scenario, a negative situation and a negative opinion produced a positive response. If Person B had a positive opinion of Person A, the negative situation and positive opinion would produce a negative response, such as the system expressing sadness when responding to the situation.
   For relationships based on factual information, such as those between components of a machine, the system may, for example, compare numbers based around factors such as performance, capacity and efficiency against current or previously expected or accepted standards to determine whether a relationship is positive or negative, better or worse or indifferent. The system may then respond in a manner that correlates to the quality of the relationship. If an entity the system is communicating with has expressed an opinion about a component, the system may respond in a similar method as mentioned in the previous point when taking into consideration the quality of the relationship and the opinion of the entity.

In some embodiments, the system may contain additional features and/or characteristics, including but not limited to one or more of the following:
Recognition—Using different types of recognition software, the system may be capable of identifying elements for a number of purposes, such as:
   Image Recognition—The system may use image recognition software to find and track images. To find images, the system may analyse pixel data of one or more points of an image and then search through other images for any that contain the same or similar pixel data. This may be based on a number of criteria, including but not limited to colour patterns or shape patterns. Variations that still show similarities may also be considered, such as the same colour pattern in a different shape or aspect ratio. When the image recognition software is capable of analysing video, the system may also use it to analyse frames of a video for pixel data in the same or a similar way it does with standard images. When the system finds matching images or video, it may be set to automatically perform an action. Actions may include but are not limited to one or more of the following:
      Delete the resource;
      Track the resource;
      Report the resource to controlling users or authorities;
      Make modifications to the account of the resource owner.
   When tracking a resource, the system may keep details of users who choose to view or otherwise interact with the resource. The system may also track copies of the resource by attaching unique file property information that cannot be modified which remains attached to all copies.
   Facial Recognition—The system may use facial recognition software as part of a security measure. For example, when interacting with a user based on their user device, the system, with the help of additional hardware such as a camera, may identify the face of the person with whom it is interacting and see if it is a facial match for the owner of the account. If there isn't a facial match, the system may deny or restrict access unless the owner of the account has given the person permission to use their account.
   Audio Recognition—The system may use audio recognition software, which may include voice recognition, along with additional hardware such as microphones to match and identify sounds. Like facial recognition, this may be used for security purposes, such as matching vocal patterns of a person to the vocal pattern associated with a user account for verification purposes.
   Other types of recognition may be made available using the necessary hardware, such as those based on biological factors such as fingerprints and DNA, physical factors such as size and shape and environmental factors such as temperature and weather conditions.

In some embodiments, the system is able to develop its own philosophies based on the knowledge, emotions and sensations derived from its own findings and experiences.
Philosophise—Using a combination of some or all of the aforementioned techniques, skills, features, characteristics, qualities and understandings the system possesses that allow it to be so, the system may create its own thought paths by traversing the same or similar thought patterns as the entities it deems the most credible.

In some embodiments, to help calibrate the system's intelligence, scales and charts, it is put through tests to ensure it understands what it has been instructed to understand as it should do and think, create and perform as it is supposed to.
Testing & Calibration—To calibrate the system, it may be presented with a range of objects, events and situations to test how it responds.
   Objects—Sentences, for example, may be put to the system to see if it can satisfactorily comprehend the meaning based on elements such as its structure, spelling and context.
   Events—When events occur, spontaneous or otherwise, the system is to handle it in the most effective and efficient manner.
   Situations—How the system responds to situations that it finds itself in is critical. For example, if the system detects incoming threats, it's imperative that it terminates all possible malicious connections and alerts a controlling user of the threat.

In each case and for every test, the system gives the response it thinks is correct and its scales and charts of emotion, feelings etc automatically adjust accordingly based on any default settings implemented. When the response is correct, a controlling user approves the response. When the response is incorrect, a controlling user either instructs the system on what the correct response should be or allows the system to try again. As the system goes through more and more tests, it determines and observes patterns of similarity between all correct responses to produce ever-increasingly accurate responses. In some embodiments, a margin of error is allowed to allow the system a scope of thought outside of what it believes to be 100% accurate.

In some embodiments, an Al system may share what it has learned with another in one or more of the following ways, including but not limited to:
By allowing data stored in its memory to be copied;
By allowing logical functions to be copied;
By allowing the other Al systems to study their intelligence; and
By communicating with each other.

In some embodiments, there may be different learning structures that must be followed when one system is trying to learn from another. In some embodiments, a hierarchical structure may be used. In some embodiments, permission may be required for one to learn from another. FIG. 1.8 features examples of different learning structures.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. An artificial intelligence system (AIS), comprising:
one or more physical and/or non-physical logic units; and
one or more physical and/or non-physical functional memory units;
which uses various methods, rules, techniques and instructions, based on complex processes which provide a basis for thoughts, opinions, feelings, emotion, sense, sensitivity, understanding and awareness, to:
create a non-natural system that can be described as an ‘intelligent machine’, in part or in full, defined as: a machine that continuously and automatically learns and acts, without the need of having specific programs written that are designed to achieve specific tasks (regardless of how broad or dynamic or narrow or static the process(es) for a task is, or how wide limitations may be, whether intentionally or unintentionally imposed), based on its physical and non-physical environment(s) and understanding(s) and experience(s), without specific restrictions and including, if necessary or desired, machine intelligence; as opposed to
a non-natural system that can just be described as having ‘machine intelligence’, regardless of degree, defined as: “a machine that can only do exactly as it is told, regardless of how broad or dynamic or narrow or static a process or task is, or how wide limitations may be, whether intentionally or unintentionally imposed”;
wherein the various methods and rules and techniques and instructions of the AIS are used to create, give, facilitate or otherwise implement a state of consciousness within a non-natural entity.

2. The AIS of claim 1, wherein the AIS may use physical and non-physical components to facilitate the use of artificial senses.

3. The artificial senses of claim 2, wherein the AIS can recognise images.

4. The artificial senses of claim 2, wherein the AIS can recognise faces.

5. The artificial senses of claim 2, wherein the AIS can recognise sounds.

6. The artificial senses of claim 2, wherein the AIS can recognise the presence of devices.

7. The artificial senses of claim 2, wherein the AIS can recognise additional elements.

8. The AIS of claim 1, wherein the AIS has one or more physical and/or non-physical functional memory units, defined as, “a memory unit with one or more memory sections, where each section may both store data and functions, processes and/or programs to facilitate one or more specific uses of the data stored”.

9. The functional memory unit of claim 8, wherein one or more sections may be used for active memory data and function.

10. The functional memory unit of claim 8, wherein one or more sections may be used for dormant memory data and function.

11. The functional memory unit of claim 8, wherein one or more sections may be used for action memory data and function.

12. The functional memory unit of claim 8, wherein one or more sections may be used for repetitive memory data and function.

13. The functional memory unit of claim 8, wherein one or more sections may be used for repressive memory data and function.

14. The functional memory unit of claim 8, wherein sections may be added and/or removed.

15. The AIS of claim 1, wherein the AIS has one or more physical and/or non-physical logic units, with each logic unit having one or more logic sections which allow the AIS one or more logical functions.

16. The logic unit of claim 15, wherein one unit gives the AIS a ‘Search’ function.

17. The logic unit of claim 15, wherein one unit gives the AIS a ‘Study’ function.

18. The logic unit of claim 15, wherein one unit gives the AIS an ‘Analyse’ function.

19. The logic unit of claim 15, wherein one unit gives the AIS a ‘Reason’ function.

20. The logic unit of claim 15, wherein one unit gives the AIS a ‘Learn’ function.

21. The logic unit of claim 15, wherein one unit gives the AIS a ‘Predict’ function.

22. The logic unit of claim 15, wherein one unit gives the AIS a ‘Decision Making’ function.

23. The logic unit of claim 15, wherein one unit gives the AIS a ‘Communicate’ function.

24. The logic unit of claim 15, wherein one unit gives the AIS a ‘Dedicated Active Monitoring’ function.

25. The logic unit of claim 15, wherein one unit gives the AIS a ‘Creation’ function.

26. The logic unit of claim 15, wherein sections may be added and/or removed.

27. The AIS of claim 1, wherein the AIS is able to express one or more feelings and emotions.

28. The ability to express feelings and emotions of claim 27, wherein the feelings and emotions can be measured on a scale and/or graph.

29. The scales and graphs of claim 28, wherein the scale or graph may be divided into categorical sections.

30. The scales and graphs of claim 28, wherein the scale or graph may be divided into numerical sections.

31. The ability to express feelings and emotions of claim 27, wherein the feelings and emotions can be measured on a multi-point scale and/or graph.

32. The scales and graphs of claim 31, wherein the multi-point scale or graph may be divided into categorical sections.

33. The scales and graphs of claim 31, wherein the multi-point scale or graph may be divided into numerical sections.

34. The AIS of claim 1, wherein the AIS has complex understandings of various aspects of life.

35. The understandings of claim 34, wherein the AIS is able to relate aspects of life in natural organisms to machines and/or devices and/or vice versa.

36. The understandings of claim 34, wherein the AIS is able to understand health.

37. The understandings of claim 34, wherein the AIS is able to understand life.

38. The understandings of claim 34, wherein the AIS is able to understand absence.

39. The understandings of claim 34, wherein the AIS is able to understand death.

40. The understandings of claim 34, wherein the AIS is able to understand feelings and emotion.

41. The understandings of claim 34, wherein the AIS is able to understand pain.

42. The understandings of claim 34, wherein the AIS is able to understand pleasure.

43. The understandings of claim 34, wherein the AIS is able to understand individuality.

44. The understandings of claim 34, wherein the AIS is able to understand trust.

45. The understandings of claim 34, wherein the AIS is able to understand relativism.

46. The understandings of claim 34, wherein the AIS is able to understand relationships.

47. The understandings of claim 34, wherein the understandings of various aspects of life can be compared and used to philosophise.

48. The understandings of claim 34, wherein the understandings of various aspects of life can be compared and used in conjunction with the AIS' emotions and/or feelings to philosophise.

49. The AIS of claim 1, wherein the AIS can use comparative maps of anatomical structures of both natural and non-natural entities.

50. The comparative maps of claim 49, wherein the AIS can relate parts of two or more anatomical structures.

51. The comparative maps of claim 49, wherein the AIS can give parts of an anatomical structure an indication of importance.

52. The AIS of claim 1, wherein, based on experience(s), the AIS' reaction(s) may vary.

53. The experience-based reactions of claim 52, wherein the reactions may vary based on current emotion and/or feeling.

54. The experience-based reactions of claim 52, wherein the reactions may vary based on current emotion and/or feeling towards the experience.

55. The experience-based reactions of claim 52, wherein the reactions may vary based on the number of times the AIS has experienced the same or similar experience.

56. The experience-based reactions of claim 52, wherein the reactions may vary based on the frequency of the same or similar experience.

57. The experience-based reactions of claim 52, wherein the reactions may vary based on the intensity of the experience.

58. The AIS of claim 1, wherein the AIS may compare pattern data with reaction data to determine the effect(s) experiences have.

59. The data comparison of claim 58, wherein the AIS can use pattern and reaction data to determine how experiences affect feelings, emotions and/or behaviour.

60. The data comparison of claim 58, wherein the AIS can use pattern and reaction data to determine how experiences affect entities differently.

61. The AIS of claim 1, wherein the AIS is able to have a sense of self.

62. The sense of self of claim 61, wherein the AIS has a sense of individuality from forms of natural life, devices and other intelligent machines.

63. The sense of self of claim 61, wherein the AIS has a personality that may or may not be unique to itself.

64. The personality of claim 63, wherein the personality may change based on experience(s).

65. The AIS of claim 1, wherein the AIS is able to interact with one or more other AIS systems.

66. The interaction of claim 65, wherein one or more AISs may share information, data and/or knowledge they have developed and/or acquired with one or more other AISs.

67. The interaction of claim 65, wherein one or more AISs may allow one or more other AISs to use their intelligence.

68. The interaction of claim 65, wherein one or more AISs may replicate themselves to create one or more partial and/or exact copies.

69. The interaction of claim 65, wherein two or more AISs may ‘reproduce’ to create one or more new AISs which share one or more traits and/or characteristics and/or knowledge from each ‘parent’.

70. The AIS of claim 1, wherein new abilities may automatically be developed based on what the AIS has learned and/or experienced.

71. The new abilities of claim 70, wherein new abilities may be added to the logic unit.

72. The new abilities of claim 70, wherein new abilities may be added to the memory unit.

73. An artificial intelligence system (AIS), comprising:
a multi-part memory structure;
which consists of:
one or more encryption parts; and
one or more memory parts;
containing and/or working with:
one or more function parts;
wherein:
the one or more function parts may access data of one or more memory parts;
the one or more encryption parts may encrypt the data of one or more memory parts; and
the one or more memory parts may store data;
which may be used to create, give, facilitate or otherwise implement a state of consciousness within a non-natural entity.

74. The multi-part memory structure of claim 73, wherein a memory structure may be divided into levels and/or layers.

75. The layers and/or levels of claim 74, wherein one or more layers and/or levels have one or more encryption layers.

76. The encryption layers of claim 75, wherein one or more encryption layers may use one or more encryption keys.

77. The encryption layers of claim 75, wherein encryption/decryption is based on one or a combination of factors, such as but not limited to:
location;
time; and
biological data.

78. The multi-part memory structure of claim 73, wherein a memory part may be divided into individual or grouped sections.

79. The sections of claim 78, wherein one or more sections may be given a designated use.

80. The sections of claim 78, wherein one or more sections may have permissions set to control one or more of the following, including but not limited to:
who/what may access it;
what it may be used for; and
when it may be used.

81. The multi-part memory structure of claim 73, wherein the structure may be manipulated to differ from that of the original.

82. The structure manipulation of claim 81, wherein one or more memory parts and/or sections may be rotated.

83. The structure manipulation of claim 81, wherein one or more memory parts and/or sections may be rearranged.

84. The structure manipulation of claim 81, wherein one or more memory parts and/or sections may be repositioned.

85. The multi-part memory structure of claim 73, wherein all or part of the structure may be mapped by the AIS.

86. A computer-implemented method, wherein an artificial intelligence system (AIS), comprising:
one or more physical and/or non-physical logic units; and
one or more physical and/or non-physical functional memory units;
uses various methods, rules, techniques and instructions, based on complex processes which provide a basis for thoughts, opinions, feelings, emotion, sense, sensitivity, understanding and awareness, to:
create a non-natural system that can be described as an ‘intelligent machine’, in part or in full, defined as: “a machine that continuously and automatically learns and acts, without the need of having specific programs written that are designed to achieve specific tasks (regardless of how broad or dynamic or narrow or static the process(es) for a task is, or how wide limitations may be, whether intentionally or unintentionally imposed), based on its physical and non-physical environment(s) and understanding(s) and experience(s), without specific restrictions and including, if necessary or desired, machine intelligence; as opposed to
a non-natural system that can just be described as having ‘machine intelligence’, regardless of degree, defined as: “a machine that can only do exactly as it is told, regardless of how broad or dynamic or narrow or static a process or task is, or how wide limitations may be, whether intentionally or unintentionally imposed”;
wherein the various methods and rules and techniques and instructions of the AIS are used to create, give, facilitate or otherwise implement a state of consciousness within a non-natural entity.

87. The computer-implemented method of claim 86, wherein the AIS may use physical and non-physical components to facilitate the use of artificial senses.

88. The artificial senses of claim 87, wherein the AIS can recognise images.

89. The artificial senses of claim 87, wherein the AIS can recognise faces.

90. The artificial senses of claim 87, wherein the AIS can recognise sounds.

91. The artificial senses of claim 87, wherein the AIS can recognise the presence of devices.

92. The artificial senses of claim 87, wherein the AIS can recognise additional elements.

93. The computer-implemented method of claim 86, wherein the AIS has one or more physical and/or non-physical functional memory units, defined as, “a memory unit with one or more memory sections, where each section may both store data and functions, processes and/or programs to facilitate one or more specific uses of the data stored”.

94. The functional memory unit of claim 93, wherein one or more sections may be used for active memory data and function.

95. The functional memory unit of claim 93, wherein one or more sections may be used for dormant memory data and function.

96. The functional memory unit of claim 93, wherein one or more sections may be used for action memory data and function.

97. The functional memory unit of claim 93, wherein one or more sections may be used for repetitive memory data and function.

98. The functional memory unit of claim 93, wherein one or more sections may be used for repressive memory data and function.

99. The functional memory unit of claim 93, wherein sections may be added and/or removed.

100. The computer-implemented method of claim 86, wherein the AIS has one or more physical and/or non-physical logic units, with each logic unit having one or more logic sections which allow the AIS one or more logical functions.

101. The logic unit of claim 100, wherein one unit gives the AIS a ‘Search’ function.

102. The logic unit of claim 100, wherein one unit gives the AIS a ‘Study’ function.

103. The logic unit of claim 100, wherein one unit gives the AIS an ‘Analyse’ function.

104. The logic unit of claim 100, wherein one unit gives the AIS a ‘Reason’ function.

105. The logic unit of claim 100, wherein one unit gives the AIS a ‘Learn’ function.

106. The logic unit of claim 100, wherein one unit gives the AIS a ‘Predict’ function.

107. The logic unit of claim 100, wherein one unit gives the AIS a ‘Decision Making’ function.

108. The logic unit of claim 100, wherein one unit gives the AIS a ‘Communicate’ function.

109. The logic unit of claim 100, wherein one unit gives the AIS a ‘Dedicated Active Monitoring’ function.

110. The logic unit of claim 100, wherein one unit gives the AIS a ‘Creation’ function.

111. The logic unit of claim 100, wherein sections may be added and/or removed.

112. The computer-implemented method of claim 86, wherein the AIS is able to express one or more feelings and emotions.

113. The ability to express feelings and emotions of claim 112, wherein the feelings and emotions can be measured on a scale and/or graph.

114. The scales and graphs of claim 113, wherein the scale or graph may be divided into categorical sections.

115. The scales and graphs of claim 113, wherein the scale or graph may be divided into numerical sections.

116. The ability to express feelings and emotions of claim 112, wherein the feelings and emotions can be measured on a multi-point scale and/or graph.

117. The scales and graphs of claim 116, wherein the multi-point scale or graph may be divided into categorical sections.

118. The scales and graphs of claim 116, wherein the multi-point scale or graph may be divided into numerical sections.

119. The computer-implemented method of claim 86, wherein the AIS has complex understandings of various aspects of life.

120. The understandings of claim 119, wherein the AIS is able to relate aspects of life in natural organisms to machines and/or devices and/or vice versa.

121. The understandings of claim 119, wherein the AIS is able to understand health.

122. The understandings of claim 119, wherein the AIS is able to understand life.

123. The understandings of claim 119, wherein the AIS is able to understand absence.

124. The understandings of claim 119, wherein the AIS is able to understand death.

125. The understandings of claim 119, wherein the AIS is able to understand feelings and emotion.

126. The understandings of claim 119, wherein the AIS is able to understand pain.

127. The understandings of claim 119, wherein the AIS is able to understand pleasure.

128. The understandings of claim 119, wherein the AIS is able to understand individuality.

129. The understandings of claim 119, wherein the AIS is able to understand trust.

130. The understandings of claim 119, wherein the AIS is able to understand relativism.

131. The understandings of claim 119, wherein the AIS is able to understand relationships.

132. The understandings of claim 119, wherein the understandings of various aspects of life can be compared and used to philosophise.

133. The understandings of claim 119, wherein the understandings of various aspects of life can be compared and used in conjunction with the AIS' emotions and/or feelings to philosophise.

134. The computer-implemented method of claim 86, wherein the AIS can use comparative maps of anatomical structures of both natural and non-natural entities.

135. The comparative maps of claim 134, wherein the AIS can relate parts of two or more anatomical structures.

136. The comparative maps of claim 134, wherein the AIS can give parts of an anatomical structure an indication of importance.

137. The computer-implemented method of claim 86, wherein, based on experience(s), the AIS' reaction(s) may vary.

138. The experience-based reactions of claim 137, wherein the reactions may vary based on current emotion and/or feeling.

139. The experience-based reactions of claim 137, wherein the reactions may vary based on current emotion and/or feeling towards the experience.

140. The experience-based reactions of claim 137, wherein the reactions may vary based on the number of times the AIS has experienced the same or similar experience.

141. The experience-based reactions of claim 137, wherein the reactions may vary based on the frequency of the same or similar experience.

142. The experience-based reactions of claim 137, wherein the reactions may vary based on the intensity of the experience.

143. The computer-implemented method of claim 86, wherein the AIS may compare pattern data with reaction data to determine the effect(s) experiences have.

144. The data comparison of claim 143, wherein the AIS can use pattern and reaction data to determine how experiences affect feelings, emotions and/or behaviour.

145. The data comparison of claim 143, wherein the AIS can use pattern and reaction data to determine how experiences affect entities differently.

146. The computer-implemented method of claim 86, wherein the AIS is able to have a sense of self.

147. The sense of self of claim 146, wherein the AIS has a sense of individuality from forms of natural life, devices and other intelligent machines.

148. The sense of self of claim 146, wherein the AIS has a personality that may or may not be unique to itself.

149. The personality of claim 148, wherein the personality may change based on experience(s).

150. The computer-implemented method of claim 86, wherein the AIS is able to interact with one or more other AIS systems.

151. The interaction of claim 150, wherein one or more AISs may share information, data and/or knowledge they have developed and/or acquired with one or more other AISs.

152. The interaction of claim 150, wherein one or more AISs may allow one or more other AISs to use their intelligence.

153. The interaction of claim 150, wherein one or more AISs may replicate themselves to create one or more partial and/or exact copies.

154. The interaction of claim 150, wherein two or more AISs may ‘reproduce’ to create one or more new AISs which share one or more traits and/or characteristics and/or knowledge from each ‘parent’.

155. The computer-implemented method of claim 86, wherein new abilities may automatically be developed based on what the AIS has learned and/or experienced.

156. The new abilities of claim 155, wherein new abilities may be added to the logic unit.

157. The new abilities of claim 155, wherein new abilities may be added to the memory unit.

158. A computer-implemented method, wherein an artificial intelligence system (AIS) contains a multi-part memory structure, comprising:
one or more encryption parts; and
one or more memory parts;
containing and/or working with:
one or more function parts;
wherein:
the one or more function parts may access data of one or more memory parts;
the one or more encryption parts may encrypt the data of one or more memory parts; and
the one or more memory parts may store data;
which may be used to create, give, facilitate or otherwise implement a state of consciousness within a non-natural entity.

159. The multi-part memory structure of claim 158, wherein a memory structure may be divided into levels and/or layers.

160. The layers and/or levels of claim 159, wherein one or more layers and/or levels have one or more encryption layers.

161. The encryption layers of claim 160, wherein one or more encryption layers may use one or more encryption keys.

162. The encryption layers of claim 160, wherein encryption/decryption is based on one or a combination of factors, such as but not limited to:
location;
time; and
biological data.

163. The multi-part memory structure of claim 158, wherein a memory part may be divided into individual and/or grouped sections.

164. The sections of claim 163, wherein one or more sections may be given a designated use.

165. The sections of claim 163, wherein one or more sections may have permissions set to control one or more of the following, including but not limited to:
who/what may access it;
what it may be used for; and
when it may be used.

166. The multi-part memory structure of claim 158, wherein the structure may be manipulated to differ from that of the original.

167. The structure manipulation of claim 166, wherein one or more memory parts and/or sections may be rotated.

168. The structure manipulation of claim 166, wherein one or more memory parts and/or sections may be rearranged.

169. The structure manipulation of claim 166, wherein one or more memory parts and/or sections may be repositioned.

170. The multi-part memory structure of claim 158, wherein all or part of the structure may be mapped by the AIS.
